(19) United States
(12) Patent Application Publication
(10) Pub. No.: US 2010/0289603 A1
(43) Pub. Date: Nov. 18, 2010

(54) CONTROL APPARATUS FOR A SWITCHING DEVICE WITH A PULL-IN COIL AND/OR A HOLDING COIL AND METHOD FOR CONTROLLING THE CURRENT FLOWING THROUGH THE COIL

(75) Inventor: Wolfgang Meid, Muelheim-Kaerlich (DE)

Correspondence Address: LEYDIG, VOIT AND MAYER, TWO PRUDENTIAL PLAZA, SUITE 4900, 180 NORTH STETSON AVENUE, CHICAGO, IL, 60601, US

(73) Assignee: MOELLER GMBH, Bonn (DE)

(21) Appl. No.: 12/665,446

(22) PCT Filed: Apr. 12, 2008
(86) PCT No.: PCT/EP08/02909

§ 371 Date: Jun. 8, 2010

(30) Foreign Application Priority Data
Jul. 9, 2007 (DE) 10 2007 031 995.0

(51) Int. Cl. H01H 51/34

(52) U.S. Cl. 335/87

(57) ABSTRACT

A control apparatus for a switching device including a contactor drive and a coil includes a pulse width-controlled switching mechanism connected to a coil and a control unit connected to the switching mechanism. The control unit is configured to generate a control signal having an adjustable pulse width and set the adjustable pulse width as a function of an input voltage signal so as to maintain a current through the coil approximately constant. The control unit is further configured to determine a voltage of the control apparatus by determining an instantaneous coil voltage of the coil and adjusting a current pulse width modulation turn-on time in accordance with the instantaneous coil voltage using at least one data processing unit.

### CROSS REFERENCE TO RELATED APPLICATIONS

This application is a U.S. National Phase application under 35 U.S.C. §371of International Application No. PCT/EP2008/002909, filed Apr. 12, 2008. The International Application was published in German on Jan. 15, 2009 as WO 2009/006952 A1 under PCT Article 21 (2).

### FIELD

The invention relates to a control apparatus for a switching device, in particular for an overvoltage release or an overload circuit breaker, with a pull-in coil and/or holding coil comprising a pulse width-controlled switching mechanism which is connected to the pull-in coil and/or holding coil, and a control unit which is connected to the switching mechanism and generates a control signal with an adjustable pulse width, and also relates to a method for controlling the current flowing through the pull-in coil and/or holding coil.

### BACKGROUND

DE 299 09 901 U1 describes a control apparatus for a contactor drive in which the control apparatus comprises a pulse width-controlled electronic switching mechanism which is connected in series to a drive coil, and a control circuit which is connected on the output side to the switching mechanism. The contactor drive has two active switching states, namely response and holding of the coil. For this purpose, two characteristic value tables with setpoints are stored in the control circuit. In addition, two circuits for the two different switching states are used to determine the momentary drive coil voltage. The two determined measured values for the drive coil voltage are transmitted to the control circuit. For converting the signals, the control circuit has two signal inputs with analog-digital converters connected upstream.

EP 0 789 378 A1 describes a control apparatus for a contactor drive which consists of a series circuit of a drive coil, a switching transistor and a precision resistor for delivering a measured value from the coil current. The measured value is supplied to a control circuit which determines a control signal for the switching transistor based on the measured value, the input voltage of the control apparatus and the switching state of the contactor drive.

Determining a coil current is complex in terms of measurement technology and controlling the current which flows through the coil is time-consuming.

### SUMMARY

In an embodiment, the present invention provides a control apparatus for a switching device including a contactor drive and a coil. The control apparatus comprises a pulse width-controlled switching mechanism connected to a coil and a control unit connected to the switching mechanism. The control unit is configured to generate a control signal having an adjustable pulse width and set the adjustable pulse width as a function of an input voltage signal so as to maintain a current through the coil approximately constant. The control unit is configured to determine a voltage of the control apparatus by determining an instantaneous coil voltage of the coil from the input voltage signal and based on a pulse width modulation time. The control unit is configured to adjust a current pulse width modulation turn-on time in accordance with the instantaneous coil voltage using at least one data processing unit. The at least one data processing unit is configured to compare the instantaneous coil voltage of the coil with a predetermined coil voltage setpoint stored in the control unit so as to determine the current pulse width modulation turn-on time for the control signal of the control unit.

### BRIEF DESCRIPTION OF THE DRAWINGS

In the following, the invention will be described in detail with reference to an embodiment illustrated in the drawings, in which:

FIG. 1 is a circuit diagram of a control apparatus according to the invention for a switching device with a pull-in coil or holding coil;

FIG. 2 is a circuit diagram of the details of the control unit of the control apparatus according to FIG. 1;

FIG. 3 is a flow chart of the determination of a new pulse width modulation turn-on time carried out by the control unit of the control apparatus according to FIG. 1; and

FIG. 4 is a voltage/time graph of a voltage signal, plotted on the turn-on time of the pulse width modulation for the control of the switching mechanism according to FIG. 1.

### DETAILED DESCRIPTION

In one embodiment, a simplified control apparatus is provided for a switching device, in particular for an overvoltage release or an overload circuit breaker, with a pull-in coil and/or holding coil. The control apparatus keeps the current approximately constant through the pull-in coil and/or holding coil of the switching device, without having to store characteristic value tables in a control unit.

In a further embodiment, the control apparatus includes a control unit configured to determin a pulse width of a control signal as a function of an input voltage signal of the control device such that the control apparatus keeps the current approximately constant through the pull-in coil and/or holding coil of the switching device.

In another embodiment, a method is provided for controlling the current flowing through a pull-in coil and/or holding coil of a switching device in that the input voltage of the switching device is established and a pulse width modulation signal for controlling a switching mechanism is determined as a function of a predeterminable voltage setpoint of the coil voltage such that the switching mechanism keeps the current approximately constant through the pull-in coil and/or holding coil of the switching device.

Thus, the control apparatus according to the invention keeps the current approximately constant through the switching device by means of a voltage measurement. A setpoint for the voltage at the coil of the switching device can be predetermined at the control apparatus as a function of the type of switching device. If the switching device as an overvoltage release or overload circuit breaker has a pull-in coil and/or holding coil and if the input voltage of the control apparatus is a direct voltage or an alternating voltage, the current is adjusted by the switching device to an approximately constant value. This is achieved by an approximately constant coil voltage and has proved to be very advantageous due to the reduced circuit expense compared to a measurement of current for adjusting a constant coil current.

The control apparatus controls the voltage at the coil of the switching device such that it corresponds to the predetermined desired voltage of the coil, independently of the switching state, response or holding of the coil.

The control signal with a controllable pulse width for the switching mechanism is generated by a control unit. The control unit is connected on the input side, for example to a voltmeter for detecting the level of the input voltage signal which transmits a current input voltage signal to the control unit. The control unit determines a current control signal with a current pulse width as a function of the transmitted input voltage signal, so that the switching mechanism keeps the coil voltage approximately constant at the coil of the switching device.

The control apparatus advantageously keeps the voltage at the current through the switching device constant independently of the switching state of the switching device (response procedure or holding operation). This avoids a complex measuring step of the current which flows through the switching device.

In order that the control apparatus can keep the current constant which flows through the pull-in coil and/or holding coil of the switching device, the coil voltage which is currently at the switching device is advantageously determined. At least one scanning device is advantageously provided for scanning the input voltage currently present in each case. This scanning device which can be part of the voltmeter scans the prevailing input voltage at predeterminable times or, if appropriate, continuously. The input voltage value determined by the voltmeter is then multiplied with the quotient of the duration of the presence of a voltage signal at the control unit (switch on time) and the period of the pulse width-modulated control signal. The resulting coil voltage value is advantageously compared with a predeterminable coil voltage setpoint and a new turn-on time for the pulse width modulation is determined therefrom.

The pulse width-controlled switching mechanism advantageously comprises a switching transistor. In a further embodiment, the switching transistor is a field effect transistor, in particular an enhancement-type n-channel field effect transistor. An advantage of using such a field effect transistor is that it can be controlled via a voltage, in this case directly via the voltage output by the control unit.

The control signal with adjustable pulse width for the switching mechanism can be generated by a pulse generator. In this case, the control unit transmits to the pulse generator the determined current pulse width of the control signal. The pulse generator can be provided separately from the control unit, thereby reducing the complexity of the control unit.

Alternatively, the pulse generator is advantageously integrated into the control unit, as a result of which the control unit can itself directly generate the control signal with an adjustable pulse width. This measure avoids having to provide a separate pulse generator.

The control unit of the control apparatus advantageously comprises at least one data processing unit for processing data, as a result of which the control unit can rapidly and efficiently detect and process the data for determining the respectively currently prevailing pulse width of the control signal. The data processing unit more preferably comprises a microcontroller. A microcontroller of this type is economical and can easily be adapted to a respective field of application.

A control unit generally has a low-resistance impedance, while a voltmeter has a high-resistance impedance. For this reason, it proves to be advantageous for the control unit to comprise an impedance converter for adapting the impedance of the high-resistance voltmeter to the low-resistance impedance of the control unit. Consequently, a voltmeter which can be used for determining the input voltage signal of the control unit is loaded only minimally and the accuracy of the detectable measured values is increased.

An impedance converter of this type advantageously comprises at least one operational amplifier, as this can be used in an economic and versatile manner. Furthermore, an operational amplifier has the advantage over discrete circuitry that stabilisation of the operating point and compensation of the temperature behaviour are unnecessary.

The data processing unit generally operates internally with digital signals. An analog signal on the input side, in this case an analog measuring signal of the voltmeter for determining the input voltage signal of the control unit should, therefore be converted. For this purpose, the data processing unit comprises an analog-digital converter which converts the analog signals into digital signals to be further processed in the data processing unit.

The switching device comprises a coil, which includes a pull-in coil and/or holding coil for actuating the overvoltage release and/or overload circuit breaker. When an alternating voltage is present on the input side, it is therefore advantageous for the control apparatus to have on the input side a rectifier circuit for rectifying an alternating voltage at the input of the control apparatus.

Furthermore, the input voltage signal of the control apparatus can also comprise, in addition to a direct voltage proportion, alternating voltage portions which can be filtered out by an advantageously provided filter circuit. A filter circuit of this type can be provided on the input side of the control apparatus.

Alternative embodiments of the control apparatus are possible, depending on the field of use of the control apparatus. Thus, for example, it is advantageous if the control method can be implemented continuously, if the input voltage of the control unit is subject to strong fluctuations. However, in other circumstances, it can also be useful if the control method can be implemented at specific adjustable times (electively), for example if it can be foreseen that the input voltage only changes at specific times. To detect such a change, implementation of the method is provided after the change in the input voltage. The accuracy with which the control apparatus keeps the current constant through the switching device can depend on the frequency of the control procedures. In order for the control apparatus to be used as flexibly as possible, it has proved to be advantageous to be able to carry out the control in an intermittent manner, in addition to the continuous and elective control, i.e. the control is carried out regularly at the same time interval, it being possible to adjust the time between two control procedures.

Provided that the accuracy of holding the current by the pull-in coil and/or holding coil of the switching device depends, inter alia, on the frequency at which the control is carried out, it is advantageous if the time between two control procedures is not greater than 150 82 s, and preferably not greater than 70 μs.

FIG. 1 shows a control apparatus 1 according to the invention for a switching device. The control apparatus 1 keeps the current approximately constant through a pull-in coil or holding coil 2 for actuating an overvoltage release or overload circuit breaker of the switching device. To avoid a complex measurement of the current which flows through the pull-in coil and/or holding coil 2, according to the invention the voltage at the pull-in coil/holding coil 2 is measured. As a result of keeping the voltage approximately constant at the pull-in coil/holding coil, regardless of whether the input voltage is AC or DC, the current flowing through the pull-in coil/holding coil 2 is also kept approximately constant. In order that the control apparatus 1 is able to keep the voltage approximately constant at the pull-in coil/holding coil 2, a switching mechanism 3 is connected to the pull-in coil/holding coil 2. In the illustrated embodiment, the switching mechanism is an n-channel field effect transistor which is connected on the drain side to the pull-in coil/holding coil 2 and is connected on the gate side to the control unit 4. The switching mechanism 3 is controlled by a control signal which has an adjustable pulse width. The switching mechanism 3 controls the voltage at the pull-in coil/holding coil 2 of the switching device as a function of the pulse width of the control signal. The control signal having an adjustable pulse width is generated by a control unit 4.

The control unit 4 compares the momentary calculated coil voltage U_{Sp} at the pull-in coil/holding coil 2 with a coil voltage setpoint U_{Sp, setpoint} stored in the control unit 4 and changes the pulse width of the control signal as a function of the compared value, so that the switching mechanism 3 keeps the coil voltage U_{Sp} approximately constant at the pull-in/holding coil 2. The control unit 4 requires the momentary input voltage U at the control apparatus 1 for comparison with the coil voltage setpoint U_{Sp, setpoint}. The input voltage U is made available to the control unit 4 via a voltmeter 5, it being possible for a scanning device 6 to be provided for scanning the input voltage U.

An alternating voltage at the input of the control apparatus 1 is converted into a direct voltage by a rectifier circuit or filter circuit 7, a conversion into a pulsating direct voltage being sufficient. The direct voltage is present at the scanning device 6 and also at the coil 2.

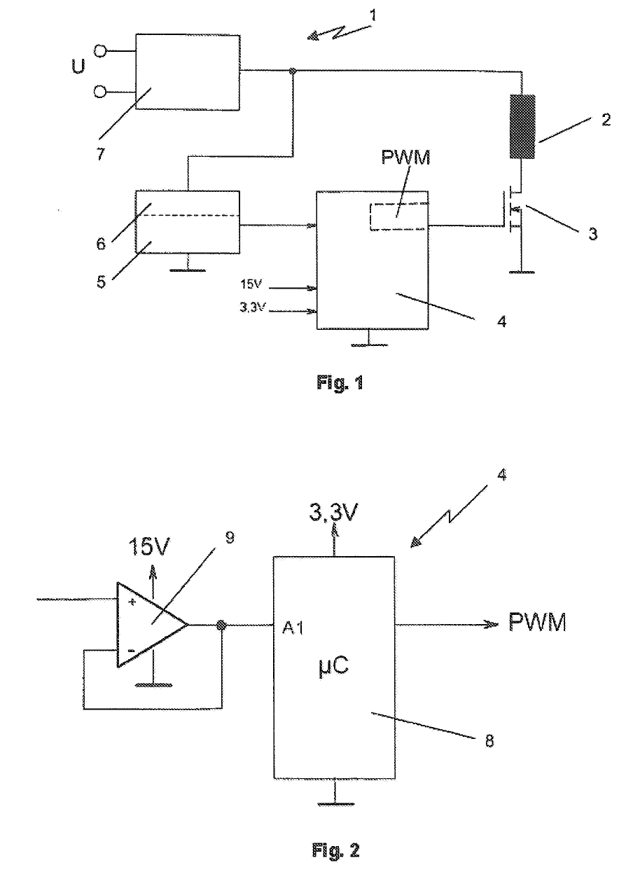

FIG. 2 shows a circuit diagram of the control unit 4 which is illustrated schematically in FIG. 1. The control unit 4 comprises a microcontroller 8 and an operational amplifier 9. The operational amplifier 9 which is connected between the input of the control unit 4 and the microcontroller 8 performs the function of an impedance converter. The control unit 4 receives the momentary input voltage U of the control apparatus 1 from the voltmeter 5, the voltmeter 5 for the most part having a high-resistance impedance, while the microcontroller 8 has a low-resistance impedance. If the operational amplifier 9 should not adapt the impedances to one another, the low-resistance impedance of the control unit would heavily load the high-resistance impedance of the voltmeter, thereby significantly reducing the accuracy of the voltmeter 5.

The value, determined by the voltmeter 5, of the input voltage U of the control apparatus 1 is an analog measured value. In order to adapt this analog measured value to the digital further processing in the microcontroller 8, an analog/digital converter A1 is provided at the input of the microcontroller 8. Using the digitalised value of the input voltage of the control apparatus 1, the prevailing time t_{On} of the pulse width modulation (=pulse width modulation turn-on time) and the period t_{PWM} (=pulse width modulation time), the microcontroller 8 determines the coil voltage U_{Sp} momentarily present at the pull-in/holding coil 2 which the microcontroller 8 compares with a stored coil voltage setpoint U_{Sp, setpoint}. The microcontroller 8 generates a new control signal having an adapted pulse width as a function of the comparative value.

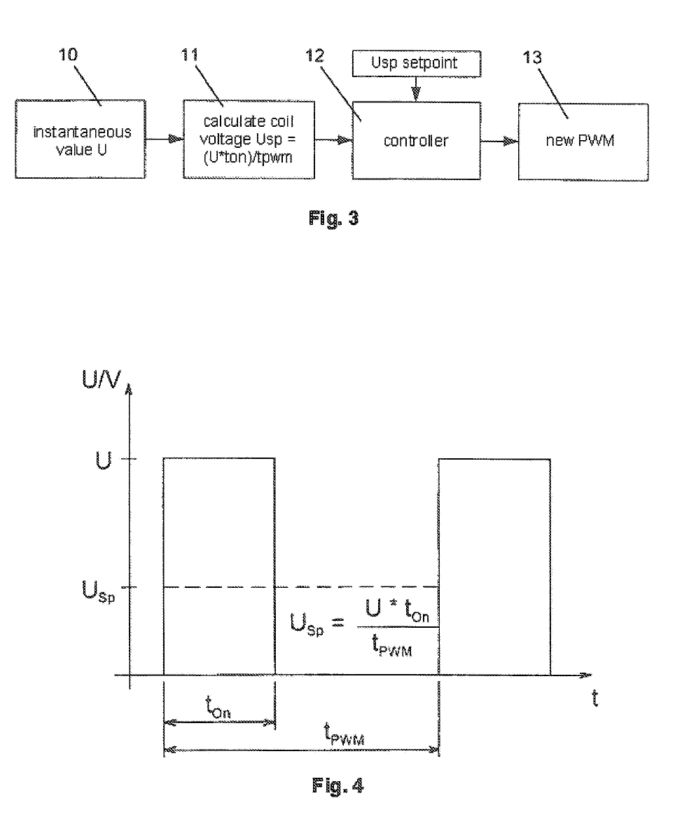

FIG. 3 shows a corresponding flow chart of this control or regulation procedure and FIG. 4 shows a voltage/time graph for the control signal having an adjustable pulse width. In a first step 10, the voltmeter 5 determines the input voltage U which is momentarily present at the control apparatus 1 and said input voltage U is scanned by the scanning device 6 and transmitted to the control unit 4. In the second step 11, the coil voltage U_{Sp} momentarily present at the pull-in/holding coil 2 is calculated. For this purpose, the input voltage value U from step 10 is multiplied by the time t_{On}, t_{On} corresponding to the pulse width of the control signal. In order to obtain the coil voltage momentarily present at the pull-in/holding coil 2, this value is divided by the period t_{PWM} of the control signal. On the graph, the result of the calculation of the coil voltage U_{Sp} is shown in FIG. 4 by a dashed line and is indicated on the voltage axis by U_{Sp}.

In the next step 12, the coil voltage U_{Sp} is compared with the predeterminable coil voltage setpoint U_{Sp,setpoint}. This takes place in a controller (see FIG. 3). The controller determines a new pulse width PWM for the control signal of the switching mechanism 3 as a function of the comparative value, such that the coil voltage U_{Sp} at the pull-in/holding coil 2 is adjusted to the coil voltage setpoint U_{Sp,setpoint}.

In the last step 13, the control signal is generated with the new pulse width PWM and is forwarded to the switching mechanism 3, as indicated in FIG. 1.

In addition to the embodiments, described above and illustrated in the drawings, one skilled in the art would appreciate that numerous other embodiments are also possible in which a respective adjustable pulse width of a control signal is adjusted as a function of a detectable input voltage of the control apparatus such that the voltage at the pull-in and/or holding coil and thus the current flowing through said pull-in and/or holding coil is kept approximately constant.

While the invention has been particularly shown and described with reference to preferred embodiments thereof, it will be understood by those skilled in the art that various changes in form and details may be made therein without departing from the spirit and scope of the invention.

1-24. (canceled)

25. A control apparatus for a switching device including a contactor drive and a coil, comprising:
a pulse width-controlled switching mechanism connected to a coil; and
a control unit connected to the switching mechanism, the control unit configured to generate a control signal having an adjustable pulse width and set the adjustable pulse width as a function of an input voltage signal so as to maintain a current through the coil approximately constant, the control unit configured to determine a voltage of the control apparatus by determining an instantaneous coil voltage of the coil from the input voltage signal and based on a pulse width modulation time, and adjusting a current pulse width modulation turn-on time in accordance with the instantaneous coil voltage using at least one data processing unit configured to compare the instantaneous coil voltage of the coil with a predetermined coil voltage setpoint stored in the control unit so as to determine the current pulse width modulation turn-on time for the control signal of the control unit.

26. The control apparatus of claim 25, wherein the coil includes at least one of a pull-up and a holding coil.

27. The control apparatus of claim 25, wherein the predetermined coil voltage setpoint is not greater than a minimum value of the input voltage of the control apparatus.

28. The control apparatus of claim 25, further comprising a voltmeter configured to measure the voltage of the control apparatus.

29. The control apparatus of claim 25, further comprising a scanning device configured to scan the input voltage signal.

30. The control apparatus of claim 25, wherein the pulse width-controlled switching mechanism comprises a switching transistor.

31. The control apparatus of claim 30 wherein the switching transistor includes a field effect transistor.

32. The control apparatus of claim 25, further comprising a pulse generator configured to generate the control signal having the adjustable pulse width.

33. The control apparatus of claim 25, wherein the at least one data processing unit comprises a microcontroller.

34. The control apparatus of claim 27, wherein the control unit comprises an impedance converter configured to adapt an impedance of the voltmeter to an impedance of the control unit.

35. The control apparatus of claim 34, wherein the impedance of the voltmeter is higher than the impedance of the control unit.

36. The control apparatus of claim 35, wherein, the impedance converter comprises at least one operational amplifier.

37. The control apparatus of claim 27, wherein the at least one data processing unit comprises an input side having an analog-digital converter configured to convert an analog measuring signal of the voltmeter into a digital signal, and wherein the at least one data processing unit is configured to further process the digital signal.

38. The control apparatus of claim 25, further comprising a rectifier circuit configured to rectify an alternating voltage input to the control apparatus.

39. The control apparatus of claim 25, further comprising a filter circuit configured to filter alternating voltage portions from the input signal of the control apparatus.

40. The control apparatus of claim 25, wherein a period between two control procedures is not greater than 150 μs.

41. A switching device having an integrated control apparatus comprising:
a pull-in or holding coil;
a pulse width-modulated switching mechanism; and
a control unit connected to the switching mechanism and configured to generate a control signal having an adjustable pulse width, wherein the control unit determines the pulse width of the control signal as a function of an input voltage signal of the control unit so as to keep a current through the coil approximately constant.

42. A method for controlling a current flowing through a coil of a switching device having a switching mechanism, comprising:
a) receiving an input voltage to the switching device; and
b) determining a pulse width modulation signal as a function of a predetermined voltage setpoint of the coil voltage so as to control the switching mechanism so as to maintain a current approximately constant through the coil of the switching device.

43. The method of claim 42, wherein (a) and (b) are performed periodically.

44. The method of claim 43, wherein (a) and (b) are performed at adjustable time intervals.

45. The method of claim 42, wherein (a) and (b) are performed intermittently.

46. The method of claim 44, wherein the time interval is not greater than 150 μs.
